(19) United States
(12) Patent Application Publication
(10) Pub. No.: US 2013/0344858 A1
(43) Pub. Date: Dec. 26, 2013

(54) CONTROL DEVICE, CONTROL METHOD, PROGRAM, AND RECORDING MEDIUM

(71) Applicant: SONY CORPORATION, Tokyo (JP)

(72) Inventor: SATOSHI SUZUNO, Saitama (JP)

(73) Assignee: SONY CORPORATION, Tokyo (JP)

(21) Appl. No.: 13/899,855

(22) Filed: May 22, 2013

(30) Foreign Application Priority Data
Jun. 21, 2012 (JP) 2012-139758

(51) Int. Cl. H04W 8/22

(52) U.S. Cl. CPC H04W 8/22
USPC 455/418

(57) ABSTRACT

There is provided an apparatus including a control device including an acquisition section configured to acquire an action performed by a first user and a position at which the action is performed, and an activation control section configured to control, based on a history regarding an activation state of a function in a case where the action has been previously performed at the position, the activation state of the function while the first user is performing the action at the position.

### BACKGROUND

The present disclosure relates to a control device, a control method, a program, and a recording medium.

In recent years, as mobile terminals such as a smartphone are gaining widespread use, an increasing number of mobile terminals have been obtaining various functions such as a function of connecting to a network, a function of detecting a position by using a GPS signal, and a wireless communication function using Wi-Fi or the like. More and more mobile terminals also have applications that operate in the backgrounds. However, for example, if the functions are used at all times, more electrical power is probably consumed than necessary.

As a way of decreasing wasteful electrical power consumption, a user may manually stop the functions as necessary or may set the functions to stop. However, even if adopting such a way, a function that is not being particularly desired is sometimes turned on so that electrical power is wastefully used. Especially when manually stopping a function, a user has to take time out for issuing an instruction to turn on or off the function.

Therefore, a technology is disclosed that, for example, predicts a communication status of a mobile terminal in a traveling route from the current position of a user to the destination, and turns on or off the communication function of the mobile terminal based on a result of the prediction (see JP 2011-061713A, for example). The communication status of the mobile terminal includes, for example, a position at which or a period during which the state of the mobile terminal changes into an offline state, and changes back into an online state.

### SUMMARY

However, while it is possible to perform activation control on the communication function based on the result of the prediction regarding the communication status with the above-described technology, it is still difficult to perform activation control on the function based on a position and an action of a user. Thus, it is desirable to provide a technology for performing activation control on the function based on the position and the action of the user.

According to an embodiment of the present disclosure, there is provided a control device including an acquisition section configured to acquire an action performed by a first user and a position at which the action is performed, and an activation control section configured to control, based on a history regarding an activation state of a function in a case where the action has been previously performed at the position, the activation state of the function while the first user is performing the action at the position.

According to another embodiment of the present disclosure, there is provided a control method including acquiring an action performed by a first user and a position at which the action is performed, and controlling, based on a history regarding an activation state of a function in a case where the action has been previously performed at the position, the activation state of the function while the first user is performing the action at the position.

According to the embodiments of the present disclosure, there is provided a program for causing a computer to function as a control device, the control device including an acquisition section configured to acquire an action performed by a first user and a position at which the action is performed, and an activation control section configured to control, based on a history regarding an activation state of a function in a case where the action has been previously performed at the position, the activation state of the function while the first user is performing the action at the position.

According to the embodiments of the present disclosure, there is provided a computer-readable recording medium having a program recorded thereon, the program causing a computer to function as a control device that includes an acquisition section configured to acquire an action performed by a first user and a position at which the action is performed, and an activation control section configured to control, based on a history regarding an activation state of a function in a case where the action has been previously performed at the position, the activation state of the function while the first user is performing the action at the position.

According to the embodiments of the present disclosure described above, it is possible to provide a technology for performing activation control on a function, based on a position and an action of a user.

### BRIEF DESCRIPTION OF THE DRAWINGS

FIG. 1 is a diagram illustrating an overview example of an activation control device according to an embodiment of the present disclosure;

FIG. 2 is a diagram illustrating an example of a configuration of a function of an activation control device according to an embodiment of the present disclosure;

FIG. 3 is a diagram illustrating an example of a configuration of history information that is used by an activation control device according to an embodiment of the present disclosure;

FIG. 4 is a diagram illustrating an example of a configuration of an activation history that is used by an activation control device according to an embodiment of the present disclosure;

FIG. 5 is a diagram illustrating an example of a configuration of schedule information that is used by an activation control device according to an embodiment of the present disclosure;

FIG. 6 is a diagram illustrating an example of a function of an activation control device according to an embodiment of the present disclosure;

FIG. 7 is a diagram illustrating an example of an operation of an activation control device according to an embodiment of the present disclosure; and

FIG. 8 is a diagram illustrating the example of the operation of the activation control device according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the present specification and the drawings, a plurality of structural elements that have substantially the same function and structure are sometimes distinguished by using different alphabets after denoted with the same reference numeral. However, when a plurality of structural elements that have substantially the same function and structure each do not have to be distinguished in particular, only the same reference numeral is used.

The “DETAILED DESCRIPTION OF THE EMBODIMENT(S)” will be made in order of the following contents.

### 1. Embodiments

### 1-1. Overview of Activation Control Device

### 1-2. Example of Functional Configuration of Activation Control Device

### 1-3. Example of Configuration of History Information

### 1-4. Example of Configuration of Activation History

### 1-5. Example of Configuration of Schedule Information

### 1-6. Example of Function of Activation Control Device

### 1-7. Example of Operation of Activation Control Device

### 2. Conclusion

### <<1. Embodiments>>

### <1-1. Overview of Activation Control Device>

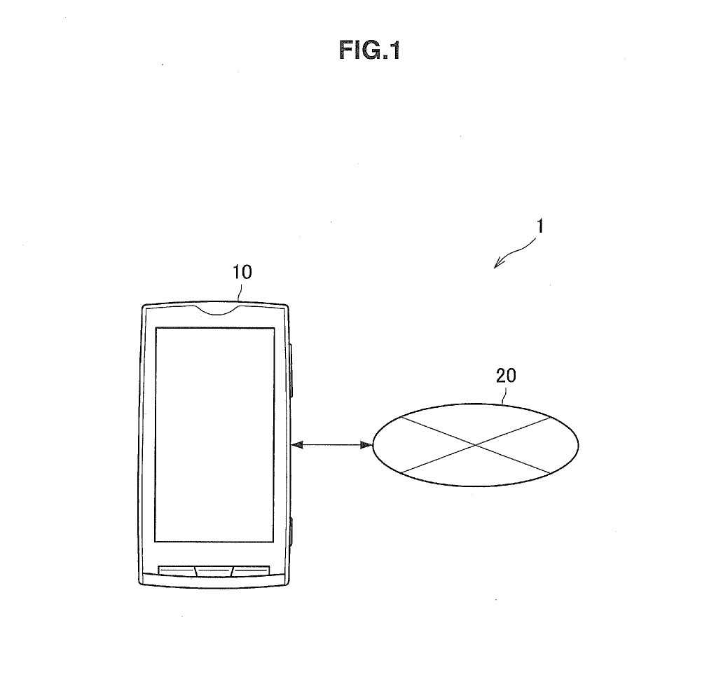

The embodiments of the present disclosure will be described one by one in detail below. First, an overview example of an activation control device 10 according to an embodiment of the present disclosure will be described. FIG. 1 is a diagram illustrating the overview example of the activation control device 10 according to the embodiment of the present disclosure.

As illustrated in FIG. 1, the activation control device 10 according to the embodiment of the present disclosure is mounted on a smartphone, as an example, and configured to be capable of communicating with another device via a network 20. That is, the activation control device 10 and the network 20 may be included in an activation control system 1. However, the overview of the activation control device 10 illustrated in FIG. 1 is just an example. For example, the activation control device 10 may be mounted on a device such as a personal computer (PC) and a tablet type computer. The activation control device 10 according to the embodiment of the present disclosure may function as an example of a control device.

Here, as described above, when various functions such as a function of connecting to a network, a function of detecting a position by using a GPS signal, and a wireless communication function using Wi-Fi or the like are turned on at all times, more electrical power is probably consumed than necessary. As a way of decreasing wasteful electrical power consumption, a user may manually stop the functions as necessary or set the functions to stop. However, even if adopting such a way, a function that is not being particularly desired is sometimes turned on so that electrical power is wastefully used. Especially when manually stopping a function, a user has to take time out for instructing the function to be turned on or off.

The technology has existed that, for example, predicts a communication status of a mobile terminal in a traveling route from the current position of a user to the destination, and turns on or off the communication function of the mobile terminal based on a result of the prediction. Although it is possible to perform activation control on the communication function based on the result of the prediction regarding the communication status by using the technology, it is still difficult to perform activation control on the function based on a position and an action of a user. Thus, in the embodiments of the present disclosure, a technology is proposed that performs activation control on the function based on the position and the action of the user.

The overview example of the activation control device 10 according to the embodiment of the present disclosure has been described above.

### <1-2. Example of Functional Configuration of Activation Control Device>

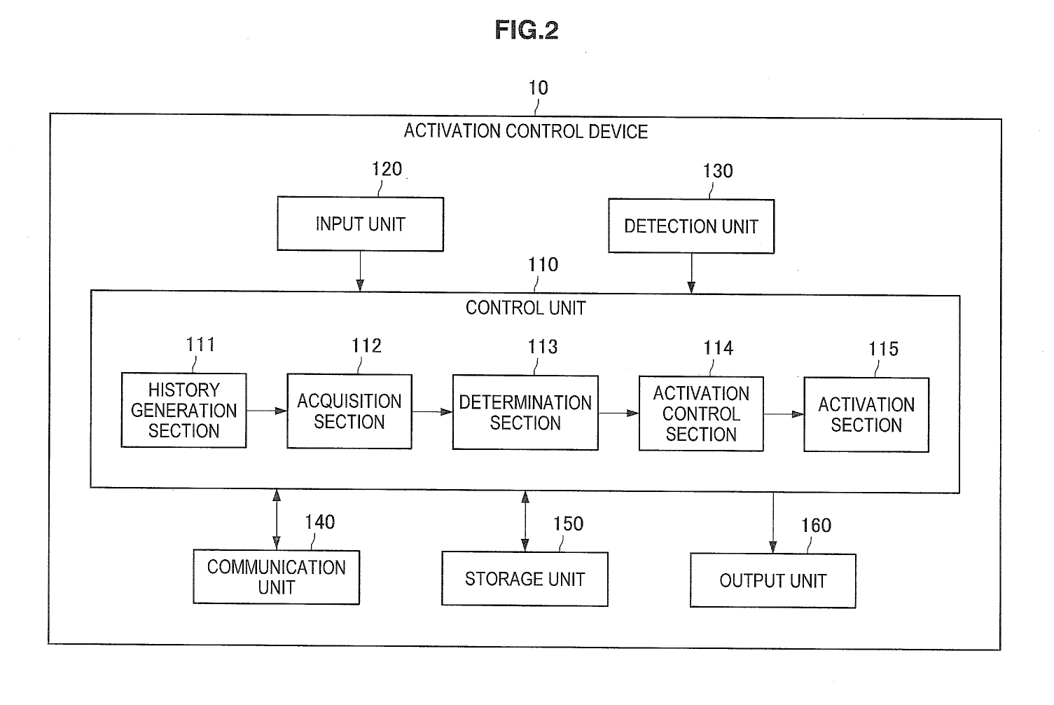

Next, an example of a functional configuration of an activation control device 10 according to an embodiment of the present disclosure will be described. FIG. 2 is a diagram illustrating the example of the functional configuration of the activation control device 10 according to the embodiment of the present disclosure. As illustrated in FIG. 2, the activation control device 10 includes a control unit 110, an input unit 120, a detection unit 130, a communication unit 140, a storage unit 150, and an output unit 160.

The control unit 110 corresponds to a processor such as a central processing unit (CPU). The control unit 110 performs various functions included in the control unit 110 by executing a program stored in the storage unit 150 or another storage medium. The control unit 110 also includes a history generation section 111, an acquisition section 112, a determination section 113, an activation control section 114, and an activation section 115. The function of each of the history generation section 111, the acquisition section 112, the determination section 113, the activation control section 114, and the activation section 115 will be described in detail below. Additionally, the determination section 113 may be included in the activation control section 114.

The input unit 120 has a function of receiving an operation from a user. The input unit 120 outputs the operation from the user to the control unit 110 as operation information. The operation information is used by the control unit 110 for, for example, executing a program. Although the input unit 120 is integrated into the activation control device 10 in the example illustrated in FIG. 2, the input unit 120 may be configured separately from the activation control device 10.

The detection unit 130 has a function of detecting the current position of a user. A way of detecting the current position of the user by the detection unit 130 is not specifically limited. For example, the detection unit 130 may detect the current position of the user by estimating the current position of the detection unit 130 based on a signal received from a GPS satellite. The current position of the detection unit 130 does not have to be estimated by the detection unit 130.

For example, when the activation control device 10 transmits, to a position estimation server, a result of reception of a signal from the GPS satellite by the detection unit 130, the position estimation server may estimate the current position of the detection unit 130. In that case, the detection unit 130 can detect the current position of the detection unit 130 that is estimated by the position estimation server. A current position of a user may be expressed in the form of longitude and latitude, polar coordinates, or a vector. The current position of the user may also be expressed in the form of three dimensional coordinates including altitude.

The communication unit 140 is a communication interface including, for example, a communication device for connecting to the network 20. For example, the communication unit 140 can communicate with another device via the network 20. The communication unit 140 may perform wireless or wired communication via the network 20. Although the communication unit 140 is integrated into the activation control device 10 in the example illustrated in FIG. 2, the communication unit 140 may be configured separately from the activation control device 10.

The storage unit 150 stores a program for operating the control unit 110 by using a storage medium such as semiconductor memory or a hard disk. For example, the storage unit 150 can also store various types of data (such as history information, an activation history, and schedule information) used by the program.

The data will be described in detail below. Although the storage unit 150 is integrated into the activation control device 10 in the example illustrated in FIG. 2, the storage unit 150 may be configured separately from the activation control device 10.

The output unit 160 includes a function of making an output in accordance with control performed by the control unit 110. For example, the output unit 160 includes a function of presenting information to a user in accordance with control performed by the control unit 110. The output unit 160 may be a display device including a function of displaying a screen or an audio output device for outputting a sound to a user. Although the output unit 160 is integrated into the activation control device 10 in the example illustrated in FIG. 2, the output unit 160 may be configured separately from the activation control device 10.

The example of the functional configuration of the activation control device 10 according to the embodiment of the present disclosure has been described above.

### <1-3. Example of Configuration of History Information>

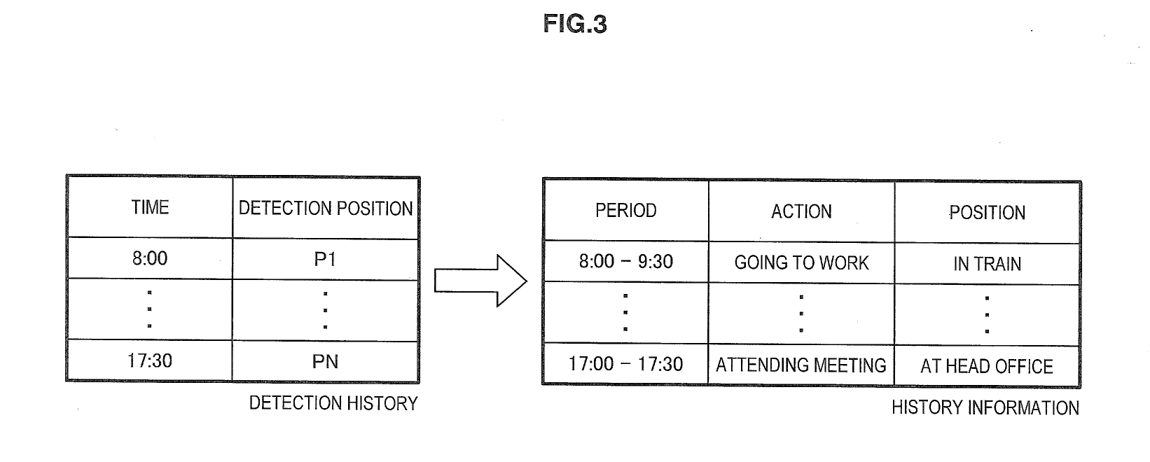

Next, an example of a configuration of history information used by an activation control device 10 according to an embodiment of the present disclosure will be described. FIG. 3 is a diagram illustrating the example of the configuration of the history information used by the activation control device 10 according to the embodiment of the present disclosure. As illustrated in FIG. 3, the history information includes a period, an action, and a position. The action included in the history information corresponds to an action of a user, and the period included in the history information corresponds to a period during which the user is performing the action. The position included in the history information corresponds to a position at which the user performs the action.

As illustrated in FIG. 3, for example, the history information may be generated from a detection history by a history generation section 111. The detection history includes time and a detection position. The detection position included in the detection history corresponds to the current position of a user that is detected by a detection unit 130. The time included in the detection history corresponds to time at which the current position of the user is detected. The time and the detection position are added to, for example, the detection history by the history generation section 111.

The addition to the detection history may be performed at predetermined intervals, or at the time of check-in at a social network. A way of generating history information from the detection history is not limited in particular. For example, an action may be recognized based on a detection position. For example, a technology disclosed in JP 2006-345269A can be used as a way of recognizing an action. If using that technology, an action of a user can be recognized by, for example, analysis of the detection position by the history generation unit 111. An example of an action includes going to work, attending meeting, and having meal.

The social network in the present specification should be taken in a broad sense and understood as a network of society for promoting communication among a plurality of people. The social network is sometimes taken in a narrow sense and understood as a network for promoting communication among people who have hobbies, occupation, residence, or the like in common, but the social network in the present specification should not be limited to the network for promoting communication among the above-described particular people.

A position included in the history information can be recognized based on the detection position. In the example illustrated in FIG. 3, a position included in the history information is expressed by information indicating an area (such as in train, at head office, at hotel, and at station). In that case, for example, the detection position can be converted into information indicating an area, based on information associated with the detection position and the information indicating the area. However, the form of the position included in the history information is not limited. For example, the position included in the history information may be expressed in the same form as the detection position.

The example of the configuration of the history information used by the activation control device 10 according to the embodiment of the present disclosure has been described above. In the case described above, the history information is a history generated when a user of the activation control device 10 performed a given action at a given position in the past. However, the history information may also be a history generated when a user other than the above-mentioned user performed the action at the position in the past.

For example, the history information may also be stored in advance by a storage unit 150, and may be acquired from the storage unit 150 by a control unit 110 as necessary. For example, the history information may also be stored in advance by a different device from the activation control device 10, and may be received from the different device by the control unit 110 as necessary.

### <1-4. Example of Configuration of Activation History>

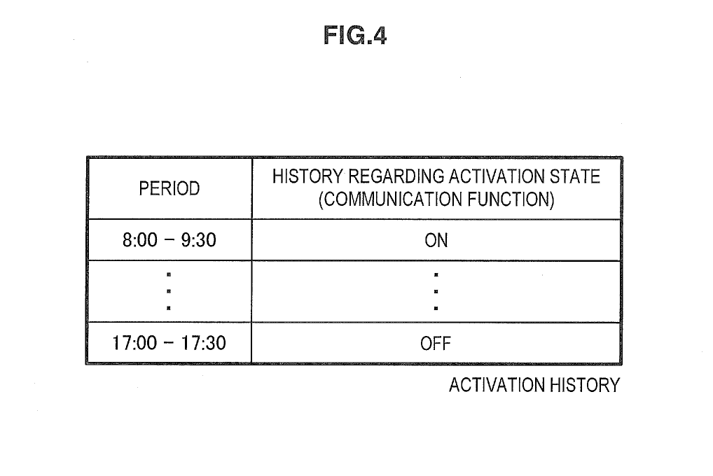

Next, an example of a configuration of an activation history used by an activation control device 10 according to an embodiment of the present disclosure will be described. FIG. 4 is a diagram illustrating the example of the configuration of the activation history used by the activation control device 10 according to the embodiment of the present disclosure. As illustrated in FIG. 4, the activation history includes a history regarding a period and an activation state. The history regarding the activation state included in the activation history corresponds to a history regarding an activation state of a function. In the example illustrated in FIG 4, the activation history includes a history regarding an activation state of a single function, but the activation history may include a history regarding each of activation states of functions.

Although a history regarding an activation state of a communication function is used as an example of a history regarding an activation state of a function here in FIG. 4, a type of a function is not limited in particular. For example, the function may be a function of detection performed by a sensor, a function of communication performed by a communication interface, or a function provided by a program. That is, the function may include at least one of the function of detection performed by the sensor, the function of communication performed by the communication interface, and the function provided by the program.

The sensor may include various types of sensors such as GPS sensor, a geomagnetic sensor, an inclination sensor, an acceleration sensor, an illuminance sensor, a gyrosensor, and a proximity sensor, and corresponds to, for example, a detection unit 130. The communication interface may include various types of communication interfaces such as 3G and Wi-fi, and corresponds to, for example, a communication unit 140. The program corresponds to, for example, an application executed by a control unit 110. The history regarding the activation state having display “ON” in FIG. 4 indicates that the function was being activated during the period. To the contrary, the history regarding the activation state having display “OFF” in FIG. 4 indicates that the function was not being activated during that period.

Histories regarding a period and an activation state are added to an activation history by, for example, a history generation section 111. The addition to the activation history may be performed at predetermined intervals.

The example of the configuration of the activation history used by the activation control device 10 according to the embodiment of the present disclosure has been described above. It has been described above that the activation history in the activation control device 10 is used, but an activation history in an activation control device that is used by a different user from a user of the activation control device 10 may be used.

The activation history may be stored in advance by, for example, a storage unit 150, and may be acquired from the storage unit 150 by the control unit 110 as necessary. The activation history may also be stored in advance by, for example, a different device from the activation control device 10, and may be received from the different device by the control unit 110 as necessary.

### <1-5. Example of Configuration of Schedule Information>

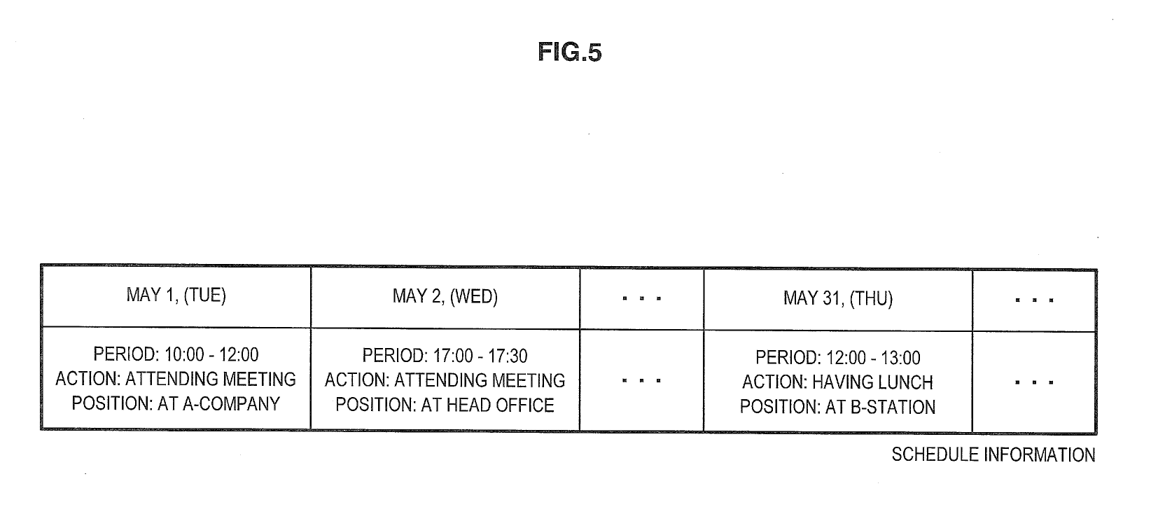

Next, an example of a configuration of schedule information used by an activation control device 10 according to an embodiment of the present disclosure will be described. FIG. 5 is a diagram illustrating the example of the configuration of the schedule information used by the activation control device 10 according to the embodiment of the present disclosure. As illustrated in FIG. 5, the schedule information includes a date, a period, an action, and a position. For example, a function included in a scheduler as an example of an application generates the schedule information by associating the schedule information with a date and a period designated by a user operation, and by inputting an action and a position designated by a user operation into the schedule information. For example, a function included in the scheduler can cause the output unit 160 to display the schedule information.

The action included in the schedule information corresponds to an action that a user will be performing during the period in the date. The position included in the schedule information corresponds to a position at which the user will perform the action. In the example illustrated in FIG. 5, the position included in the schedule information is expressed by information indicating an area (such as in train, at head office, at hotel, and at station). However, the form of the position included in the schedule information is not limited. For example, the position included in the schedule information may be expressed in the same form as a position included in history information.

The example of the configuration of the schedule information used by the activation control device 10 according to the embodiment of the present disclosure has been described above. For example, the schedule information may be stored in advance by a storage unit 150, and may be acquired from the storage unit 150 by a control unit 110 as necessary. For example, the schedule information may also be stored in advance by a different device from the activation control device 10, and may be acquired from the different device by the control unit 110 as necessary.

### <1-6. Example of Function of Activation Control Device>

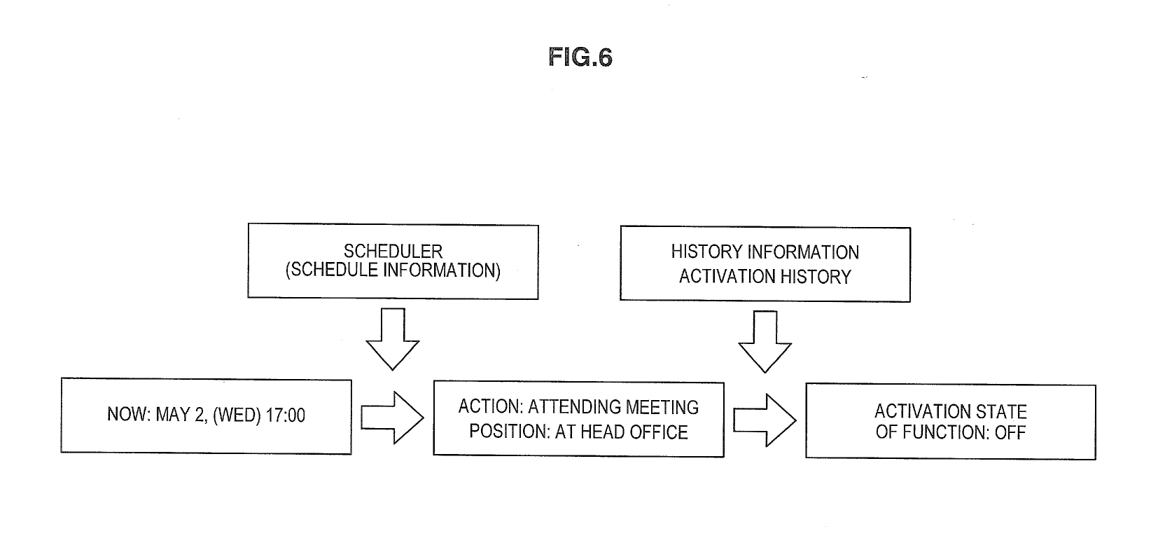

Next, an example of a function of an activation control device 10 according to an embodiment of the present disclosure will be described. FIG. 6 is a diagram illustrating the example of the function of the activation control device 10 according to the embodiment of the present disclosure.

First, an acquisition section 112 acquires an action performed by a user and a position at which the action is performed. For example, the acquisition section 112 may acquire, as the action performed by the user, an action registered in schedule information. For example, the acquisition section 112 may also acquire, as the position at which the action is performed, a position registered in the schedule information. In this way, if the action performed by the user and the position at which the action is performed are acquired from the schedule information, it is possible to save electrical power that are used by a sensor to detect the position and the action.

In that case, for example, the acquisition section 112 may acquire an action and a position at time corresponding to a current date and current time (or time a predetermined period after the current time) from schedule information. FIG. 6 illustrates an example in which when the current date is “May 2, (Wed),” and the current time is “17:00,” the acquisition section 112 acquires, from the schedule information, an action “attending meeting” and a position “at head office” during “May 2, (Wed), 17:00 to 17:30,” which corresponds to the current date and includes the current time.

Next, a determination section 113 determines whether to activate a function, based on a history regarding an activation state of the function that indicates whether the function was activated when the action was performed at the position in the past. For example, when the function “ON” is set in the history regarding the activation state, the determination section 113 may determine that the function is activated. To the contrary, for example, when the function “OFF” is set in the history regarding the activation state, the determination section 113 may also determine that the function is not activated.

Alternatively, for example, when the function “ON” is set in the history regarding the activation state more frequently than a predetermined value, the determination section 113 may determine that the function is activated. For example, when the function “ON” is not set in the history regarding the activation state more frequently than a predetermined value, the determination section 113 may also determine that the function is not activated.

Next, an activation control section 114 controls, based on a result of the determination performed by the determination section 113, the activation state of the function while the user is performing the action at the position. For example, a period while the user is performing the action at the position is grasped by using a period included in the schedule information.

For example, when it is determined that the function is activated, the activation control section 114 may control an activation section 115 such that the function while the user is performing the action at the position is activated by the activation section 115. For example, when it is determined that the function is not activated, the activation control section 114 may also control the activation section 115 such that the function while the user is performing the action at the position is not activated by the activation section 115.

Referring to the history information illustrated in FIG. 3 and the activation history illustrated in FIG. 4, a history regarding an activation state of a communication function indicates “OFF” when the action “attending meeting” was performed at the position “at head office” in the past. In that case, as illustrated in FIG. 6, for example, the activation control section 114 may perform control such that the communication function while the user is performing the action at the position, i.e., “May 2, (Wed), 17:00 to 17:30,” is not activated.

The example of the function of the activation control device 10 according to the embodiment of the present disclosure has been described above. It is possible in accordance with the example of the function to acquire an action performed by a user and a position at which the action is performed. It is also possible to control, based on a history regarding an activation state of a function when the action was performed at the position in the past, the function while the user is performing the action at the position. Thus, it is possible to performed activation control on the function based on a position and an action of a user. Accordingly, utility for a user is prevented from decreasing, while electrical power is hopefully saved.

The embodiments of the present disclosure have been described in detail above.

### <1-7. Example of Operation of Activation Control Device>

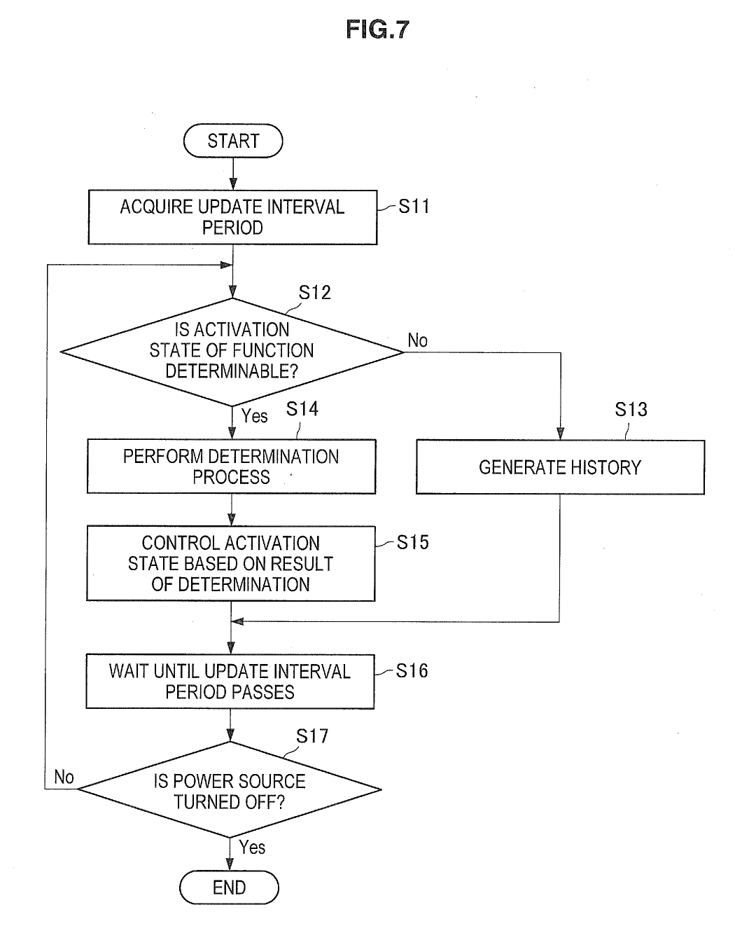

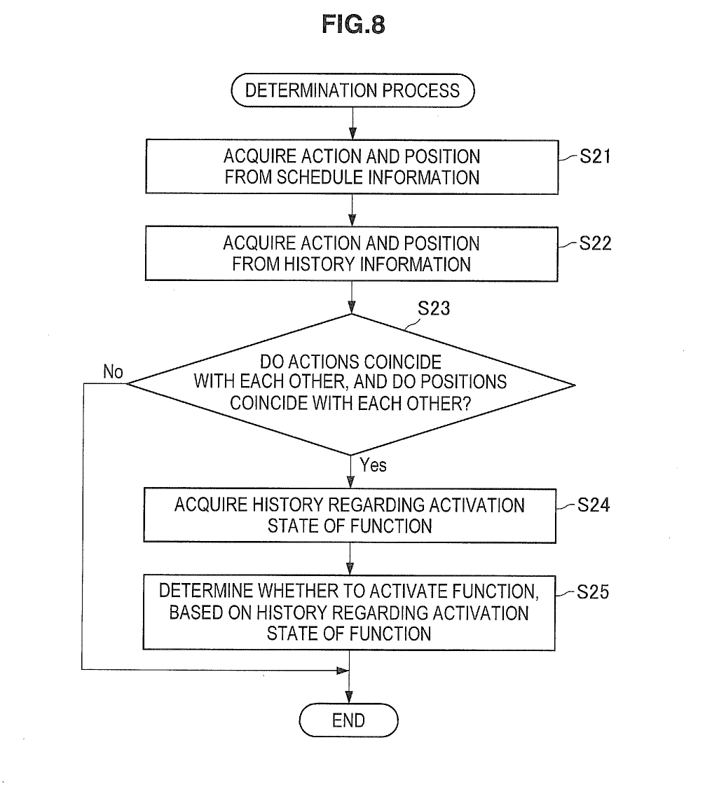

Next, an example of an operation of an activation control device 10 according to an embodiment of the present disclosure will be described. FIGS. 7 and 8 are diagrams illustrating the example of the operation of the activation control device 10 according to the embodiment of the present disclosure.

First, an acquisition section 112 acquires an update interval period (S11), and a determination section 113 determines whether an activation state of a function is determinable (S12). When the determination section 113 determines that the activation state of the function is not determinable (“No” in S12), a history generation section 111 generates a history (such as history information and an activation history) (S13) to proceed to S16. For example, when there is no activation history of the function, the activation state of the function is not determinable.

Meanwhile, when the determination section 113 determines that the activation state of the function is determinable (“Yes” in S12), a determination process is performed (S14). In the determination process, the acquisition section 112 first acquires an action and a position from schedule information (S21), and then acquires an action and a position from history information (S22).

Next, the determination section 113 determines whether the action and the position acquired from the schedule information coincide with the action and the position acquired from the history information, respectively (S23). When the actions do not coincide with each other, or when the positions do not coincide with each other (“No” in S23), the determination section 113 finishes the determination process. To the contrary, when the actions coincide with each other, and the positions coincide with each other (“Yes” in S23), then the acquisition section 112 acquires a history regarding an activation state of a function (S24), and the determination section 113 determines, based on the history regarding the activation state of the function, whether to activate the function (S25).

Next, an activation control section 114 controls the activation state based on a result of the determination (S15). A control unit 110 waits until an update interval period passes (S16), determines whether to turn a power source off (S17), and returns to S12 when it is determined that the power source is not turned off (“No” in S17), but turns the power source on to finish the process when it is determined that the power source is turned off (“Yes” in S17).

A single action and a single position, or a plurality of actions and a plurality of positions may be acquired from the history information. When a plurality of actions and positions are acquired from the history information, the acquisition section 112 may decide the number of samples to be acquired, and may acquire the number of actions and positions for the samples from the history information. It may also be determined whether a function is activated, in accordance with how frequently the function is activated.

### <2. Conclusion>

As described above, it is possible in accordance with the embodiments of the present disclosure to realize an activation control device including an acquisition section configured to acquire an action performed by a user and a position at which the actions is performed, a determination section configured to determine, based on a history regarding an activation state of a function when the action was performed at the position in the past, whether to activate the function, and an activation control section configured to control, based on a result of determination performed by the determination section, the activation state of the function while the user is performing the action at the position.

In accordance with the configuration, a technology is realized for performing activation control on a function based on a position and an action of a user. Utility for a user is hereby prevented from decreasing, while electrical power is hopefully saved. Furthermore, since activation control on a function is automatically learned based on a history, the intended advantageous effect is expected whether a user is aware or not. Moreover, if an action performed by a user and a position at which the action is performed are acquired from schedule information, it is possible to save electrical power that is used by a sensor to detect the position and the action.

It should be understood by those skilled in the art that various modifications, combinations, sub-combinations and alterations may occur depending on design requirements and other factors insofar as they are within the scope of the appended claims or the equivalents thereof.

For example, since information presented by an output unit 160 has to be viewed by a user, it is assumed that the output unit 160 is included in a terminal that the user can view. Meanwhile, it is also assumed that a part or all of an acquisition section 112, a determination section 113, and an activation control section 114 are provided in a server different from the terminal. For example, when the determination section 113 is provided in the server, the server has to transmit a result of determination performed by the determination section 113 to the terminal. In that case, the above-described control performed by the activation control section 114 on the activation state of the function includes the transmission, by the server, of the result of the determination performed by the determination section 113.

Each step in an operation of an activation control device 10 in the present specification does not necessarily have to be processed in chronological order described as a flowchart. For example, each step in the operation of the activation control device 10 may be processed in order different from the order described as the flow chart, or may be processed in parallel.

It is also possible to manufacture a program for causing hardware such as a CPU, ROM and RAM included in a computer to perform a function equivalent to the configuration of the above-described activation control device 10. There may also be provided a computer-readable recording medium having the program recorded thereon.

Additionally, the present technology may also be configured as below.

(1) A control device including:

an acquisition section configured to acquire an action performed by a first user and a position at which the action is performed; and

an activation control section configured to control, based on a history regarding an activation state of a function in a case where the action has been previously performed at the position, the activation state of the function while the first user is performing the action at the position.

(2) The control device according to (1),

wherein the activation control section determines whether to activate the function, based on the history regarding the activation state of the function in a case where the action has been previously performed at the position.

(3) The control device according to (1),

wherein the acquisition section acquires, as the action performed by the first user, an action registered in schedule information.

(4) The control device according to (1),

wherein the acquisition section acquires, as the position at which the action is performed, a position registered in schedule information.

(5) The control device according to (1),

wherein the function includes at least one of a function of detection performed by a sensor, a function of communication performed by a communication interface, and a function provided by a program.

(6) The control device according to (1),

wherein the history includes a history in a case where the action has been previously performed at the position by a second user other than the first user.

(7) A control method including:

acquiring an action performed by a first user and a position at which the action is performed; and

controlling, based on a history regarding an activation state of a function in a case where the action has been previously performed at the position, the activation state of the function while the first user is performing the action at the position.

(8) A program for causing a computer to function as a control device, the control device including

an acquisition section configured to acquire an action performed by a first user and a position at which the action is performed, and

an activation control section configured to control, based on a history regarding an activation state of a function in a case where the action has been previously performed at the position, the activation state of the function while the first user is performing the action at the position.

(9) A computer-readable recording medium having a program recorded thereon, the program causing a computer to function as a control device that includes

an acquisition section configured to acquire an action performed by a first user and a position at which the action is performed, and

an activation control section configured to control, based on a history regarding an activation state of a function in a case where the action has been previously performed at the position, the activation state of the function while the first user is performing the action at the position.

The present disclosure contains subject matter related to that disclosed in Japanese Priority Patent Application JP 2012-139758 filed in the Japan Patent Office on Jun. 21, 2012, the entire content of which is hereby incorporated by reference.

What is claimed is:

1. A control device comprising:
an acquisition section configured to acquire an action performed by a first user and a position at which the action is performed; and
an activation control section configured to control, based on a history regarding an activation state of a function in a case where the action has been previously performed at the position, the activation state of the function while the first user is performing the action at the position.

2. The control device according to claim 1,
wherein the activation control section determines whether to activate the function, based on the history regarding the activation state of the function in a case where the action has been previously performed at the position.

3. The control device according to claim 1,
wherein the acquisition section acquires, as the action performed by the first user, an action registered in schedule information.

4. The control device according to claim 1,
wherein the acquisition section acquires, as the position at which the action is performed, a position registered in schedule information.

5. The control device according to claim 1,
wherein the function includes at least one of a function of detection performed by a sensor, a function of communication performed by a communication interface, and a function provided by a program.

6. The control device according to claim 1,
wherein the history includes a history in a case where the action has been previously performed at the position by a second user other than the first user.

7. A control method comprising:
acquiring an action performed by a first user and a position at which the action is performed; and
controlling, based on a history regarding an activation state of a function in a case where the action has been previously performed at the position, the activation state of the function while the first user is performing the action at the position.

8. A program for causing a computer to function as a control device, the control device including
an acquisition section configured to acquire an action performed by a first user and a position at which the action is performed, and
an activation control section configured to control, based on a history regarding an activation state of a function in a case where the action has been previously performed at the position, the activation state of the function while the first user is performing the action at the position.

9. A computer-readable recording medium having a program recorded thereon, the program causing a computer to function as a control device that includes
an acquisition section configured to acquire an action performed by a first user and a position at which the action is performed, and
an activation control section configured to control, based on a history regarding an activation state of a function in a case where the action has been previously performed at the position, the activation state of the function while the first user is performing the action at the position.
